(19) United States
(12) Patent Application Publication
(10) Pub. No.: US 2009/0072546 A1
(43) Pub. Date: Mar. 19, 2009

(54) QUICK DISCONNECT SWIVEL LUG

(75) Inventor: Khanh Phu Nguyen, Wilsonville, OR (US)

Correspondence Address: FENNEMORE CRAIG, P.C., 1700 Lincoln Street, SUITE 2900, DENVER, CO, 80203, US

(73) Assignee: CLIMAX MOLYBDENUM COMPANY, Phoenix, AZ (US)

(21) Appl. No.: 11/854,876

(22) Filed: Sep. 13, 2007

(51) Int. Cl. E05C 9/02; B21D 53/00; E05C 5/00

(52) U.S. Cl. 292/6; 29/428

(57) ABSTRACT

A quick disconnect swivel formed of a body, an arm, and a biasing member. The body includes a shaft, which extends generally outwardly from the body along a pivot axis. The arm includes a post, which extends generally outwardly from the arm, the arm defining an opening therein sized to receive the shaft so that the arm can be pivoted with respect to the body about the pivot axis between an opened position and a closed position, and the post and the body forming a lug when the arm is in the closed position. The bias member is operatively associated with the body and the arm and applies an axial force to the body and the arm. The body and the arm cooperatively engage one another to convert the axial force into a rotational force, the rotational force biasing the arm toward the closed position.

### BACKGROUND

The present invention relates generally to fastener hardware, and more particularly to a swivel lug.

Attachment lugs are typically used as a handle or support to which hooks or straps are connected to fasten two parts together. A lug typically includes a loop through which a strap may be threaded. A hook or other fastener alternatively may be clipped to the loop. A lug may be fixedly mounted to a device, or may be mounted in such a way as to allow the lug to swivel with respect to the device on which it is mounted. Often the lug is permanently closed. Others may be configured to allow opening of the lug. In some designs, a lug may be opened using a swivel mechanism. Lugs that open require more parts than permanently closed lugs. For example, a plunger type swivel lug is formed with seven different components and requires a user to unscrew a sleeve, then push a plunger and rotate an arm to open the lug. A need has developed for a simple lug, using few pieces, that is durable, as well as being easy and cost-effective to manufacture, assemble and utilize.

### SUMMARY OF THE INVENTION

The following summary is provided as a brief overview of the claimed invention. It shall not limit the invention in any respect, with a detailed and fully enabling disclosure being set forth in the Detailed Description of the Invention section. Likewise, the invention shall not be restricted in any component, dimension, material, parameter, operating condition or other variable unless otherwise stated herein. In an embodiment, a swivel comprises a body comprising a shaft having a proximal end and a distal end, the shaft extending generally outwardly from the body along a pivot axis; an arm comprising a post which extends generally outwardly from the arm, the arm defining an opening therein sized to receive the shaft of the body so that the arm can be pivoted with respect to the body about the pivot axis between an opened position and a closed position, the post of the arm and the body forming an attachment lug when the arm is in the closed position; and a bias member operatively associated with the body and the arm, the bias member applying an axial force to the body and the arm, the axial force being generally parallel to the pivot axis, the body and the arm cooperatively engaging one another to convert the axial force exerted by the bias member into a rotational force, the rotational force biasing the arm toward the closed position.

In another embodiment, the swivel comprises a body comprising a shaft having a proximal end and a distal end, the shaft extending generally outwardly from the body along a pivot axis, the body comprising a cam follower; an arm comprising a post, the post extending generally outwardly from the arm, the arm defining an opening therein sized to receive the shaft of the body so that the arm can be pivoted with respect to the body about the pivot axis between an opened position and a closed position, the post of the arm and the body forming an attachment lug when the arm is in the closed position, the arm comprising a cam portion sized to engage the cam follower of the body; and a bias member operatively associated with the body and the arm, the bias member applying an axial force to the body and the arm, the axial force being generally parallel to the pivot axis, the cam follower of the body engaging the cam of the arm to convert the axial force exerted by the bias member into a rotational force, the rotational force biasing the arm toward the closed position.

In another embodiment, a swivel comprises an arm comprising a post and a shaft, the post and the shaft extending generally outwardly from the arm, the shaft extending along a pivot axis, the arm also comprising a cam follower; a body defining an opening therein sized to receive the shaft of the arm so that the arm can be pivoted with respect to the body about the pivot axis between an opened position and a closed position, the body and the post of the arm forming an attachment lug when the arm is in the closed position, the body comprising a cam sized to engage the cam follower of the arm; and a bias member operatively associated with the body and the arm, the bias member applying an axial force to the body and the arm, the axial force being generally parallel to the pivot axis, the cam follower of the arm engaging the cam of the body to convert the axial force exerted by the bias member into a rotational force, the rotational force biasing the arm toward the closed position.

In another embodiment, a method for assembling a swivel comprises interrelating a bias member and a shaft, the shaft being attached to a body and comprising a cam follower, inserting the shaft into an arm, the arm comprising a cam, such that the cam follower engages the cam and the bias member exerts an axial force; mushrooming the shaft to maintain the axial force; and causing the axial force to be converted into a rotational forcer thereby moving the arm from an open position to a closed position.

### BRIEF DESCRIPTION OF THE DRAWINGS

The accompanying figures, which are incorporated herein and form a part of the specification, illustrate various embodiments of the present invention and together with the description serve to explain the invention. In the figures:

FIG. 1 illustrates an exploded view of cooperating swivel components;

FIG. 2 shows two views of a swivel body;

FIG. 3 shows a cross-section of the body;

FIG. 4 shows a view from the underside of a shafts including a raised portion of a cam follower and the cam follower of the body;

FIG. 5 shows two views of a swivel arm;

FIG. 6 shows a cross-section of the arm;

FIG. 7 shows a cam of the arm along section A-A from FIG. 6;

FIG. 8 shows an opening of the arms as well as a distal end of a post of the arm, along section C-C from FIG. 6;

FIG. 9 shows a recessed portion, including the cam, of the arm, which is Detail B of FIG. 6;

FIG. 10 shows a bias member placed over the shaft of the body;

FIG. 11 shows the shaft inserted in the arm;

FIG. 12 shows a mushroom portion of the shaft and the manner in which the arm may be moved from an open position to a closed position;

FIG. 13 illustrates an assembled swivel of the present invention;

FIG. 14 illustrates a method of assembling the swivel; and

FIG. 15 illustrates a method of disconnecting the swivel.

### DETAILED DESCRIPTION OF THE INVENTION

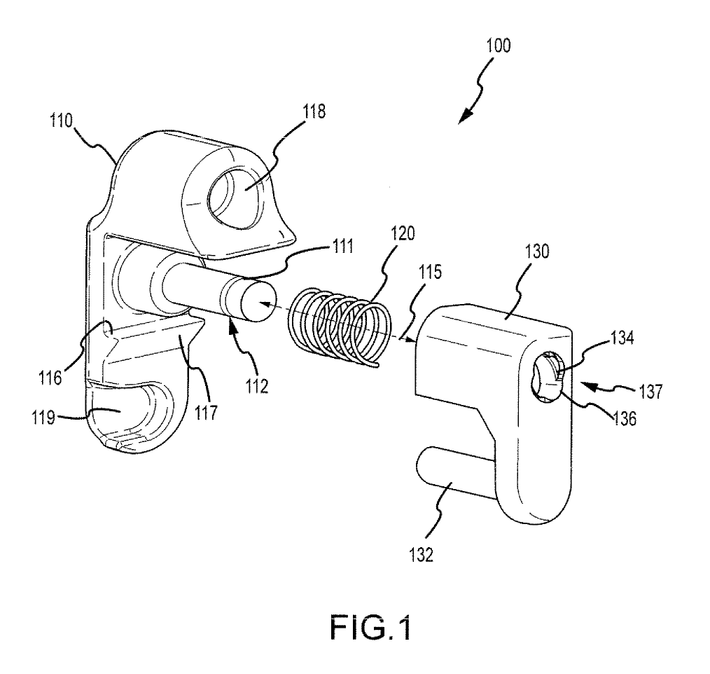

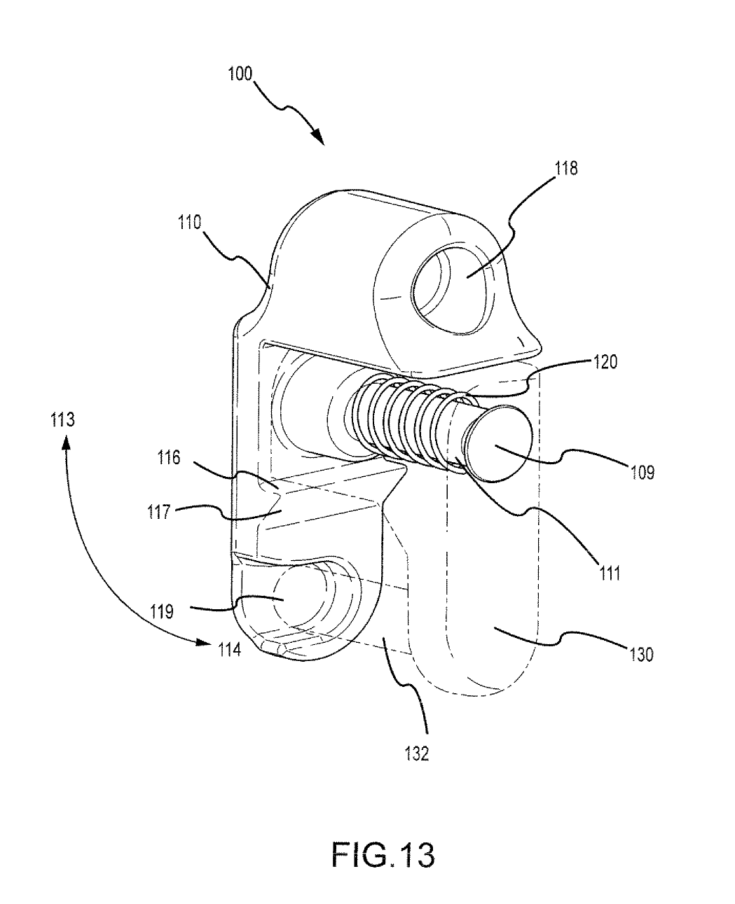

A quick disconnect swivel lug, or swivel, 100 of the present invention comprises a swivel body 110, a bias member 120, and a swivel arm 130. FIG. 1 shows an exploded view of the body 110, arm 130 and bias member 120. The body 110 comprises a shaft 111 extending generally outwardly from the body 110 along a pivot axis 115. Bias member 120 is seated on the shaft 111. The arm 130 comprises a post 132 extending generally outwardly from the arm 130. The arm 130 comprises an opening 134 configured to receive the shaft 111 (onto which bias member 120 has been seated) so that the arm 130 can be pivoted with respect to the body 110 about the pivot axis 115 between an opened position 113 and a closed, or locked, position 114, as will be explained in more detail below. In the closed position 114, illustrated in FIG. 13, the arm 130, bias member 120 and body 110 cooperate to form swivel 100.

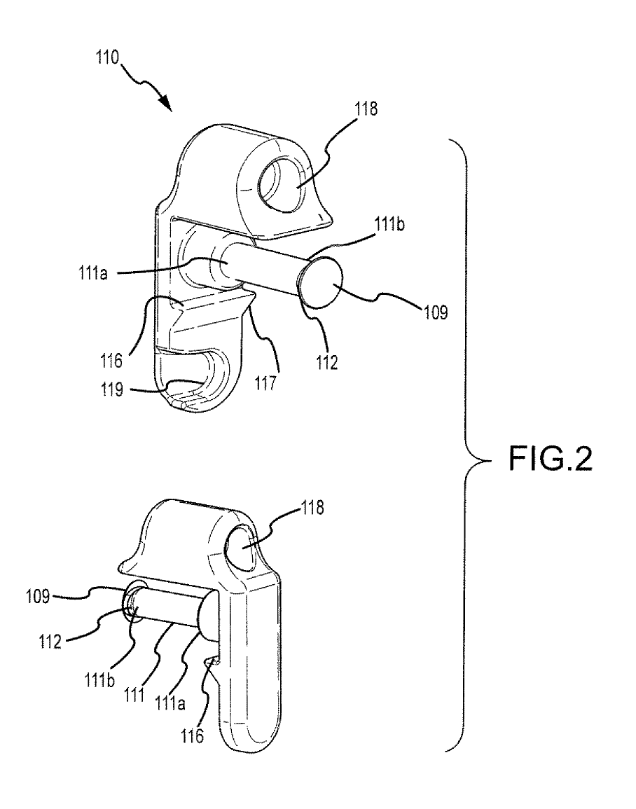

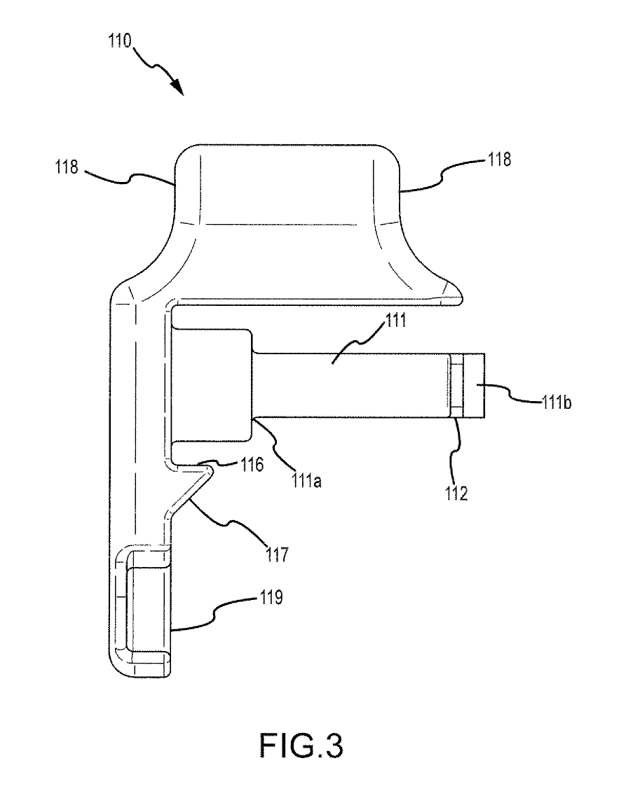

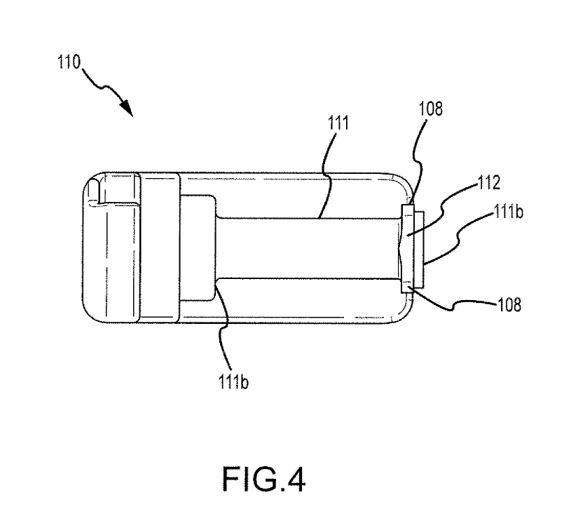

FIGS. 2-4 show various components of the body 110. The shaft 111 has proximal end 111a which may be integrally attached to the body 110. FIGS. 2 and 3 show cam follower 112, which is operatively associated with distal end 111b of the shaft 111. As illustrated in FIGS. 2-4, cam follower 112 comprises a raised portion 108 at the distal end 111b of shaft 111, such that the cam follower 112 is operatively associated with the distal end 111b of shaft 111. The body 110 may also comprise first travel stop 116, second travel stop 117, mounting lug 118 and recessed portion 119. FIG. 3 shows a cross-section of body 110 in which the components and their relationship to one another can be clearly seen. FIG. 4 shows a view from the underside of body 110, in which shaft 111, distal end 111b, raised portion 108 of cam follower 112, and cam follower 112 may be clearly seen. Although FIG. 2 shows body 110 prior to assembly with arm 130, it also shows a mushroomed portion 109 of shaft 111, which would not be in evidence until after arm 130 has been attached to body 110, as explained in more detail below.

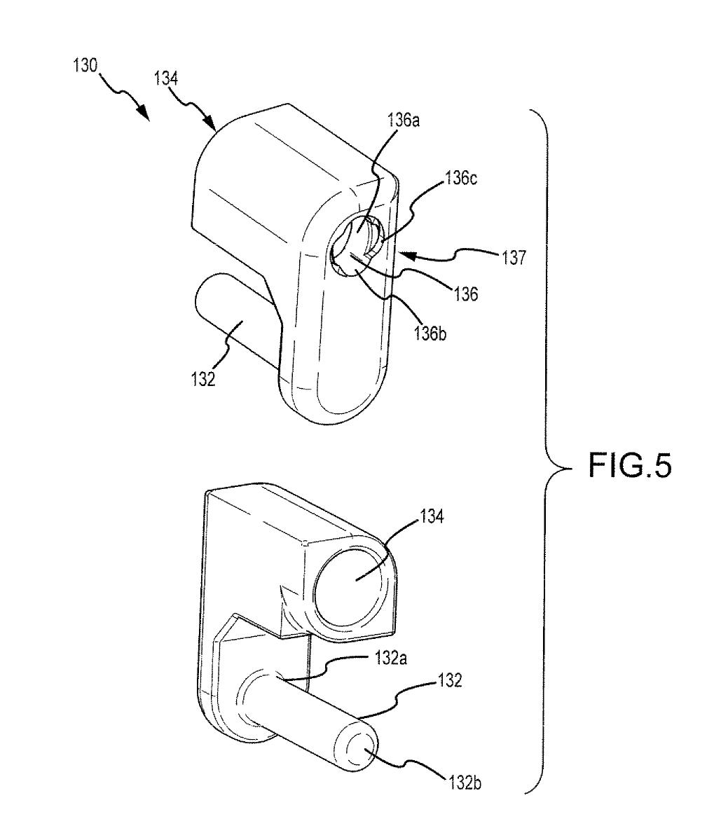

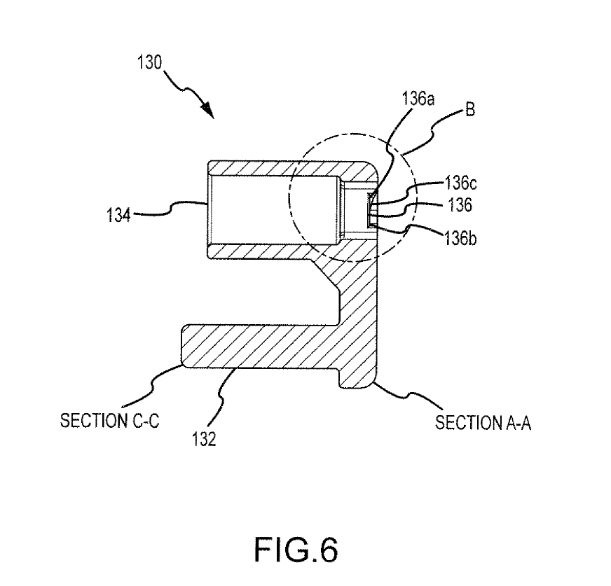

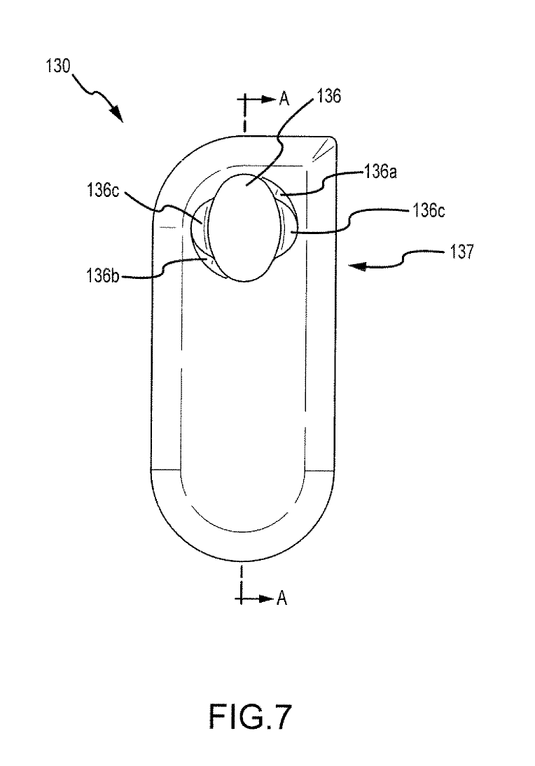

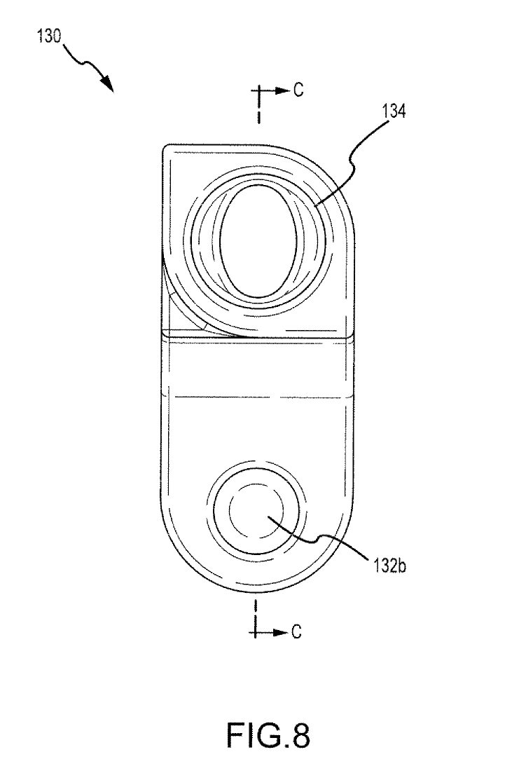

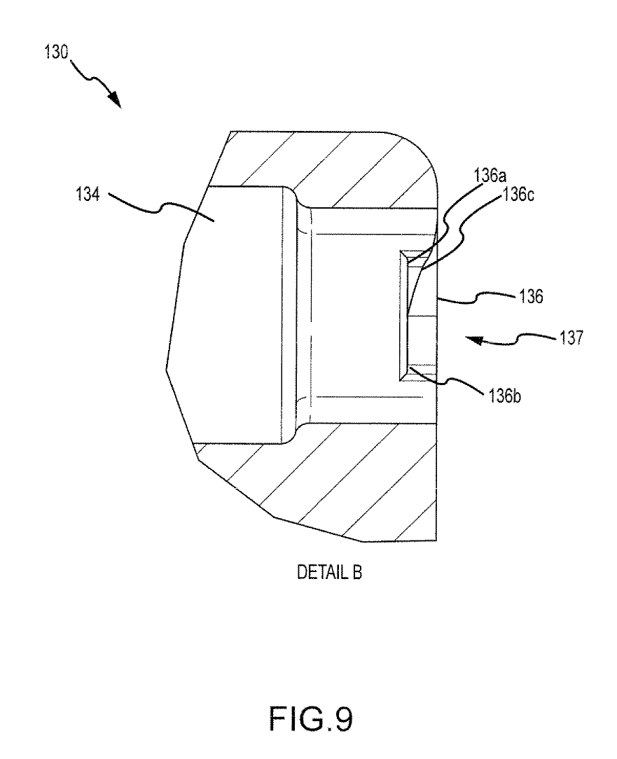

FIGS. 5-9 show various components of arm 130. Arm 130 comprises opening 134 for receiving shaft 111. As shown in FIG. 5, opening 134 is connected to recessed portion 137 which comprises an upper section 136a, a lower section 136b and a ramp section 136c, the upper 136a, lower 136b, and ramp 136c sections comprising a cam portion, or cam 136. The cam 136 may be sized and/or shaped for engaging cam follower 112 when body 110, bias member 120 and arm are assembled to form swivel 100. The cam 136 may be generally concentric with the opening 134 in the arm 130.

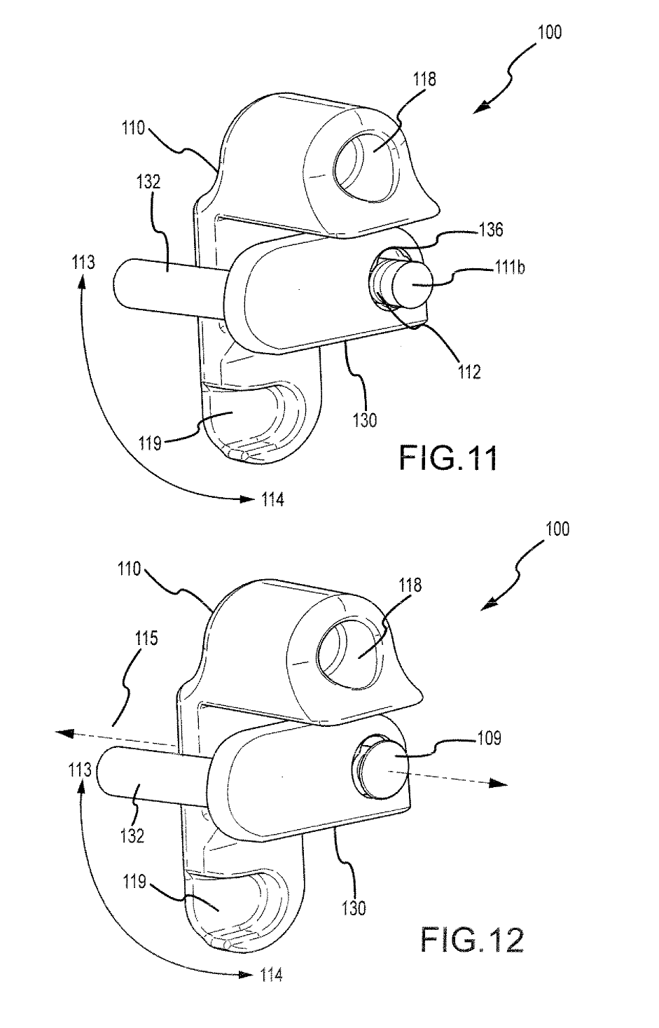

Post 132 may be integrally attached to arm 130 at proximal end 132a. The recessed portion 119 of body 110 is configured to receive the distal end 132b of post 132 when arm 130 is pivoted from open position 113 to closed position 114 (see FIGS. 11-13)

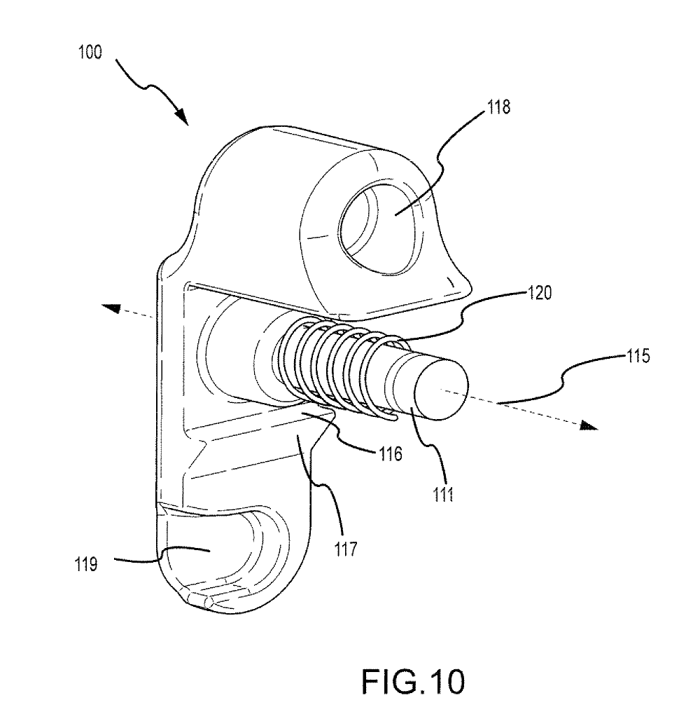

Swivel 100 also comprises bias member 120, which may be a spring. As shown in FIG. 10, bias member 120 fits over shaft 111 and aligns with shaft 111 in a generally concentric manner. When arm 130 is assembled with body 110 and bias member 120, bias member 120 biases the arm 130 toward the closed position 114, forming swivel 100 (see FIG. 13). In one embodiment, the bias member 120 is a compression spring which, when compressed, applies an axial force to the body 110 and the arm 130. The axial force is generally parallel to the pivot axis 115. The body 110 and arm 130 cooperatively engage one another (via cam 136 and cam follower 112) to convert the axial force exerted by the bias member 120 into a rotational force, thereby biasing the arm 130 toward or in the closed position 114.

In another embodiment, the shaft 111 may be integrally attached to arm 130, while the post 132 may be integrally attached to the body 110. Other components would also be relocated from the body 110 to the arm 130 and vice-versa to allow the shaft 111 and the post 132 to be received in the reciprocating member in accordance with the teachings herein.

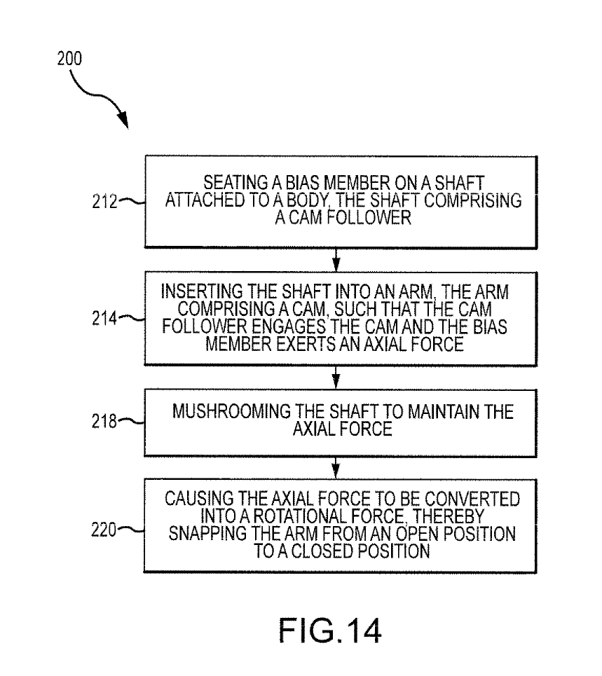

Next will be described a method 200 for assembling the swivel 100 components, as illustrated in FIG. 14. As shown in FIG. 10, the method 200 may comprise fitting 210 bias member 120 over the over the distal end 111b of the shaft 111 and seating 212 the bias member 120 against the body 110 by sliding the bias member 120 over the shaft 111.

Method 200 may further comprise inserting 214 the distal end 111b of shaft 111 into opening 134 of arm 130, such that bias member 120 is seated on the shaft 111 and compressed, and cam follower 112 is caused to engage cam 136. Opening 134 can best be seen in FIG. 5. Given the shape and size of cam follower 112 in relation to cam 136, shaft 111 of body 110 may only be inserted 214 in opening 134 of the arm 130 (such that cam follower 112 may engage cam 136) if post 132 is generally parallel in orientation to shaft 111 (see FIG. 11). In the embodiment shown, second travel stop 117 prevents arm 130 from rotating about pivotal axis 115 beyond the point of the open position 113.

Once shaft 111 is inserted in opening 134 such that cam follower 112 engages cam 136, the method further comprises mushrooming 218 the distal end 111b of shaft 111 to create mushroomed portion 109, thereby maintaining the compression of bias member 120 (see FIG. 12). Mushrooming 218 may be accomplished by applying pressure to distal end 111b causing it to deform and form mushroomed portion 109. Mushroomed portion 109 prevents bias member 120 from expending axial force to dislodge arm 130. In another embodiment, instead of being formed from shaft 111, mushroomed portion 109 may be a separate piece that is installed on the distal end 111b of shaft 111 in a manner that would be familiar to one of ordinary skill in the art after becoming familiar with the teachings of the invention.

Once the mushroomed portion 109 is in place, the force exerted by bias member 120 in conjunction with the action of the cam 136 and cam follower 112 causes the arm to rotate about the pivot axis 115 forcing post 132 into recess 119, thereby moving/snapping the arm 130 into the closed position 114. When cam follower 112 engages cam 136, the axial force exerted by bias member 120 is converted into rotational force, causing arm 130 to move from the open position 113 to the closed position 114 as shown in FIGS. 12 and 13. In this action, the cam follower 112 may engage cam 136 such that the raised portion 108 of the cam follower 112 rides along the upper 136a, lower 136b, and ramp 136c sections of the recessed portion 137 comprising the cam 136. Thus, the method 200 further comprises causing 220 the axial force exerted by bias member 120 to be converted into rotational force, thereby pivoting arm 130 about pivot axis 115 and moving or snapping arm 130 from the open position 113 to the closed position 114. First travel stop 116 prevents the arm 130 from further rotating past the point of the closed position 114. The method 200 further comprises biasing the arm 130 in the closed position.

Once the swivel 100 has been assembled as described herein, the swivel may be mounted to a device, implement or part (not shown) using mounting lug 118. Mounting lug section 118 may be a slot in the body 110 used to affix the swivel 100 to another device by way of a bolt, a screw, a cord, a strap or other fastening means.

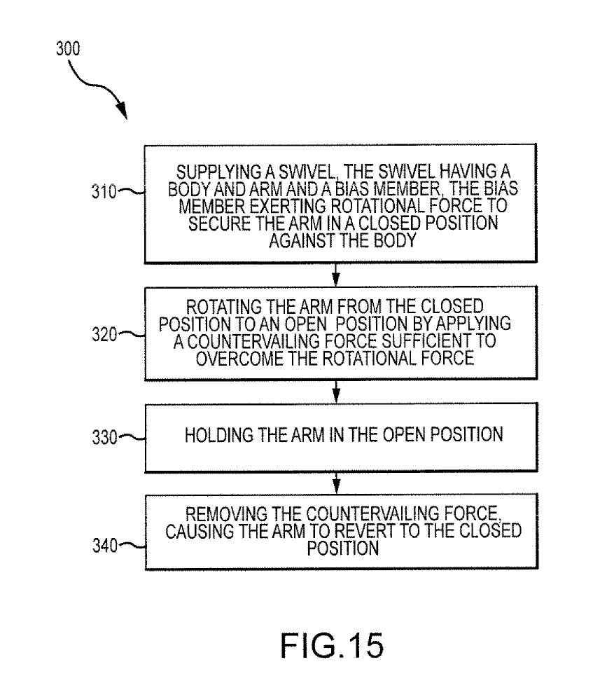

FIG. 15 illustrates method 300 for disconnecting swivel 100. Method 300 may comprise supplying 310 swivel 100. Method 300 may further comprise rotating 320 arm 130 from the closed position 114 towards the open position 113 by applying a countervailing force sufficient to overcome the rotational force of the bias member 120, thereby opening swivel 100. Optionally, a fastener, such as a strap, a hook, a loop, another lug, etc. may be removed from or inserted in the open swivel 100, while holding 330 the arm 130 in the open position 113. The method 300 may further comprise removing 350 the force holding the arm 130 in the open position 113, causing the arm 130 to snap back or revert to the closed position 114. If a fastener was inserted into the swivel 100 while the swivel 100 was open, it is now retained in the swivel 100.

The body 110 and arm 130 may ideally be formed of metal using metal injection molding techniques. Molds of each of the body 110 and arm 130, including all of the aforementioned features such as the cam 136, cam follower 112, etc. are designed and built. In metal injection molding, liquid metal is injected into the molds to fill the cavities of the mold. The mold is then cooled, opened, and the parts ejected. Any excess flashing (unwanted metal such as the metal remaining in the injection tunnel of the mold through which the liquid metal travels between entry of the mold and the mold cavity) is removed, and the body 110 and/or arm 130 are ready for use. Other techniques for metal injection molding may also be used as would be familiar to one of ordinary skill in the art. Using metal injection molded parts provides for a durable swivel 100 that is easy and cost-effective to manufacture, assemble and use. In addition, the combination of the positive stop and biased assembly provides an element of safety by securing the swivel 100 in the closed position 114 unless actively held open. Swivel 100 has particular utility in military, law enforcement and field applications where durability, safety, and easy utilization are desired.

Alternatively, the body 110 and arm 130 may be formed of plastics, composites and other materials suitable for molding as would be familiar to one of ordinary skill in the art after becoming familiar with the teachings of this invention.

Having herein set forth preferred embodiments of the present invention, it is anticipated that suitable modifications can be made thereto which will nonetheless remain within the scope of the invention. The invention shall therefore only be construed in accordance with the following claims:

What is claimed is:

1. A swivel, comprising:
a body, the body comprising a shaft having a proximal end and a distal end, the shaft extending generally outwardly from the body along a pivot axis;
an arm, the arm comprising a post, the post extending generally outwardly from the arm, the arm defining an opening therein sized to receive the shaft of the body so that the arm can be pivoted with respect to the body about the pivot axis between an opened position and a closed position, the post of the arm and the body forming an attachment lug when the arm is in the closed position; and
a bias member operatively associated with the body and the arm, the bias member applying an axial force to the body and the arm, the axial force being generally parallel to the pivot axis, the body and the arm cooperatively engaging one another to convert the axial force exerted by the bias member into a rotational force, the rotational force biasing the arm toward the closed position.

2. The swivel of claim 1, wherein the arm comprises a cam portion and wherein the body comprises a cam follower, the cam follower engaging the cam portion to convert the axial force exerted by the bias member into the rotational force.

3. The swivel of claim 1, wherein the body comprises a cam portion and wherein the arm comprises a cam follower, the cam follower engaging the cam portion to convert the axial force into the rotational force.

4. A swivel, comprising:
a body, the body comprising a shaft having a proximal end and a distal end, the shaft extending generally outwardly from the body along a pivot axis, the body comprising a cam follower;
an arm, the arm comprising a post, the post extending generally outwardly from the arm, the arm defining an opening therein sized to receive the shaft of the body so that the arm can be pivoted with respect to the body about the pivot axis between an opened position and a closed position, the post of the arm and the body forming an attachment lug when the arm is in the closed position, the arm comprising a cam portion sized to engage the cam follower of the body; and
a bias member operatively associated with the body and the arm, the bias member applying an axial force to the body and the arm, the axial force being generally parallel to the pivot axis, the cam follower of the body engaging the cam of the arm to convert the axial force exerted by the bias member into a rotational force, the rotational force biasing the arm toward the closed position.

5. The swivel of claim 4, wherein the cam portion is generally concentric with the opening defined by the arm and wherein the cam follower is operatively associated with the distal end of the shaft.

6. The swivel of claim 5, wherein the arm comprises a recessed portion, the recessed portion being generally concentric with the opening defined by the arm, the recessed portion comprising an upper section, a lower section, and a ramp section, the upper, lower, and ramp sections comprising the cam.

7. The swivel of claim 6, wherein the cam follower comprises a raised portion provided on the distal end of the shaft, the raised portion riding along the upper, lower, and ramp sections of the recessed portion of the arm.

8. The swivel of claim 4, wherein the body further comprises a mounting lug section.

9. The swivel of claim 4, wherein the body further defines a first travel stop sized to engage the arm when the arm is in the closed position, the first travel stop preventing further rotation of the arm beyond the closed position.

10. The swivel of claim 9, wherein the body further defines a second travel stop sized to engage the arm when the arm is in the opened position, the second travel stop preventing further rotation of the arm beyond the opened position.

11. The swivel of claim 4, wherein the bias member comprises a coil spring.

12. The swivel of claim 4, wherein the body defines a recessed portion therein for receiving the post of the arm when the arm is in the closed position.

13. A swivel, comprising:
a body, the body comprising a shaft having a proximal end and a distal end, the shaft extending generally outwardly from the body along a pivot axis,
an arm, the arm comprising a post the post extending generally outwardly from the arm, the arm defining an opening therein sized to receive the shaft of the body so that the arm can be pivoted with respect to the body about the pivot axis between an opened position and a closed position, the post of the arm and the body forming an attachment lug when the arm is in the closed position;
a bias member operatively associated with the body and the arm, the bias member applying an axial force to the body and the arm, the axial force being generally parallel to the pivot axis; and
means operatively associated with the body and the arm for converting the axial force exerted by the bias member into a rotational force, the rotational force biasing the arm toward the closed position.

14. A swivel, comprising:
an arm, the arm comprising a post and a shaft, the post and the shaft extending generally outwardly from the arm, the shaft extending along a pivot axis, the arm also comprising a cam follower;
a body, the body defining an opening therein sized to receive the shaft of the arm so that the arm can be pivoted with respect to the body about the pivot axis between an opened position and a closed position, the body and the post of the arm forming an attachment lug when the arm is in the closed position, the body comprising a cam sized to engage the cam follower of the arm; and
a bias member operatively associated with the body and the arm, the bias member applying an axial force to the body and the arm, the axial force being generally parallel to the pivot axis, the cam follower of the arm engaging the cam of the body to convert the axial force exerted by the bias member into a rotational force, the rotational force biasing the arm toward the closed position.

15. A swivel, comprising:
a body;
a shaft having a proximal end and a distal end, the proximal end of the shaft being mounted to the body so that the shaft extends generally outwardly from the body along a pivot axis;
an arm defining an opening therein sized to receive the shaft so that the arm can be pivoted with respect to the body about the pivot axis between an opened position and a closed position;
a post having a proximal end and a distal end, the proximal end of the post being mounted to the arm so that the post extends generally outwardly from the body, the post and the body forming an attachment lug when the arm is in the closed position;
a bias member operatively associated with the body and the arm, the bias member applying an axial force to the body and the arm, the axial force being generally parallel to the pivot axis;
a cam operatively associated with the arm;
a cam follower operatively associated with the body, the cam follower engaging the cam to convert the axial force exerted by the bias member into a rotational force, the rotational force biasing the arm toward the closed position.

16. A method for assembling a swivel comprising,
interrelating a bias member and a shaft, the shaft being attached to a body and comprising a cam follower;
inserting the shaft into an arm, the arm comprising a cam, such that the cam follower engages the cam and the bias member exerts an axial force on the arm and the body;
mushrooming the shaft to maintain the axial force, and
causing the axial force to be converted into a rotational force, thereby moving the arm from an open position to a closed position.

17. The method of claim 16, further comprising mounting the swivel to a device.

18. The method of claim 16, wherein causing the axial force to be converted into the rotational force occurs by interaction of the cam and the cam follower.

19. The method of claim 16, further comprising preventing the arm from rotating past the open position.

20. The method of claim 16 further comprising preventing the arm from rotating past the closed position.

21. A method for disconnecting a swivel, comprising:
supplying a swivel, the swivel comprising a body, an arm, and a bias member, the bias member exerting a rotational force to secure the arm against the body in a secured position;
rotating the arm away from the body by applying a countervailing force sufficient to the arm overcome the rotational force, causing the swivel to open;
removing the countervailing force, causing the arm to revert to the secured position.

22. The method of claim 21, further comprising continuing to apply the countervailing force to the arm to hold the swivel open.

23. The method of claim 22, further comprising removing a fastening means from the swivel.
